(19) United States
(12) Patent Application Publication
(10) Pub. No.: US 2009/0144523 A1
(43) Pub. Date: Jun. 4, 2009

(54) MULTIPLE-SIMD PROCESSOR FOR PROCESSING MULTIMEDIA DATA AND ARITHMETIC METHOD USING THE SAME

(76) Inventors: Chun Gi LYUH, Daejeon (KR); Tae Moon ROH, Daejeon (KR); Jong Dae KIM, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/174,988

(22) Filed: Jul. 17, 2008

(30) Foreign Application Priority Data
Nov. 29, 2007 (KR) 10-2007-0122575

(51) Int. Cl. G06F 15/80; G06F 9/02

(52) U.S. Cl. 712/22; 712/E09.002

(57) ABSTRACT

A multiple-single instruction multiple data (SIMD) processor and an arithmetic method using the same are disclosed. When various arithmetic operations should be individually carried out by SIMD arithmetic units, control right is sub-divided to perform the arithmetic operations, such that the time of the arithmetic operations can be shortened and the efficiency thereof can be raised. When sub-divided control is not required, the control right is withdrawn and the arithmetic operations are carried out using a minimum number of program memories and a minimum number of SIMD arithmetic units, such that memory and power consumption thereof can be reduced.

### CROSS-REFERENCE TO RELATED APPLICATION

This application claims priority to and the benefit of Korean Patent Application No. 2007-122575, filed Nov. 29, 2007, the disclosure of which is incorporated herein by reference in its entirety.

### BACKGROUND

1. Field of the Invention

The present invention relates to a multiple-single instruction multiple data (SIMD) processor and an arithmetic method using the same, and more particularly, to a multiple-SIMD processor operable in further various operating modes by differently assigning control rights to control units according to arithmetic types, and an arithmetic method using the same.

This work was supported by the IT R&D program of MIC/IITA[2006-S-006-02, Components/Module technology for Ubiquitous Terminals].

2. Discussion of Related Art

Processors may be classified as a single chip processor such as a CPU usable in a personal computer or an embedded processor usable in a system on chip (SoC) such as a smart card chip or a chip for various types of control.

The embedded processor (MPU/MCU/DSP) is a core block within the SoC for processing a series of tasks in which an instruction is fetched, decoded, and executed, a signal is processed, and the processed signal is read/written. In general, the embedded processor is widely used for arithmetic operations and signal processing.

In the above-described embedded processor, a parallel pipeline structure for performance improvement is widely used. Representative parallel pipeline structures are an SIMD structure and a multiple instruction multiple data (MIMD) structure. The SIMD structure processes multiple data in a single instruction and the MIMD structure processes multiple data in multiple instructions.

FIG. 1A is a block diagram of a processor of a conventional SIMD structure and FIG. 1B is a block diagram of a processor of a conventional MIMD structure.

Referring to FIG. 1A, in the processor of the conventional SIMD structure, one control unit CU₁ reads one instruction from one program memory M₁, transfers the instruction to N arithmetic units OU₁˜OU_{N}, and controls all the arithmetic units to perform the same arithmetic operation.

This SIMD structure is advantageous in that a minimized program memory may be used, but is disadvantageous in that various arithmetic operations may not be simultaneously performed.

Referring to FIG. 1B, in the processor of the conventional MIMD structure, one control unit CU₁ simultaneously reads one instruction from each of N program memories M₁˜M_{N}, transfers instructions to N arithmetic units OU₁˜OU_{N}, and controls the N arithmetic units OU₁˜OU_{N} to perform different arithmetic operations.

This MIMD structure may simultaneously perform various arithmetic operations, but is disadvantageous in that a large number of program memories are required to control all the arithmetic units.

As a method for achieving the advantages of both the SIMD structure and the MIMD structure, a processor of a multiple-SIMD structure as shown in FIG. 1C has been disclosed.

FIG. 1C is a block diagram of a processor of a conventional multiple-SIMD structure. In the processor of the conventional multiple-SIMD structure, one control unit CU₁ simultaneously reads one instruction from each of N program memories M₁˜M_{N}, transfers instructions to N SIMD arithmetic units SOU₁˜SOU_{N}, and controls the SIMD arithmetic units SOU₁˜SOU_{N} to perform different arithmetic operations.

There is an advantage in that the processor of the multiple-SIMD structure may perform a lager number of arithmetic operations than that of the SIMD structure while employing a smaller number of memories than that of the MIMD structure. However, various arithmetic operations are significantly restricted since the SIMD arithmetic units should all be controlled.

As another method for achieving the advantages of both the SIMD structure and the MIMD structure, a processor of a multimode structure as shown in FIG. 1D has been disclosed.

FIG. 1D is a block diagram of the processor of the conventional multimode structure. When operating in the SIMD mode, a first control unit CU₁ reads one instruction from a first program memory M₁, transfers the instruction to N arithmetic units OU₁˜OU_{N}, and controls all the arithmetic units OU₁˜OU_{N} to perform the same arithmetic operation. When operating in the MIMD mode, N control units CU₁˜CU_{N} read one instruction from each of N program memories M₁˜M_{N}, transfer instructions to corresponding arithmetic units OU₁˜OU_{N}, and control the arithmetic units OU₁˜OU_{N} to perform different arithmetic operations. When a large-capacity arithmetic operation is not required, single instruction single data (SISD) control performing only one arithmetic operation by causing the first control unit CU₁ to read one instruction from the first program memory M₁ and transferring the instruction to only the first arithmetic unit OU₁ is possible.

There is an advantage in that the processor of the multimode structure may use various control modes according to types of arithmetic operations to be carried out. However, a relatively large number of control units should be used to control the N arithmetic units, thus there is a problem in that a size of hardware may increase and consumption power may increase. Since only one program memory is used in SIMD and SISD control modes, an unnecessary program memory waste may occur. Moreover, the use of control units may be limited to only one or all control units, thereby lowering usability, efficiency, and flexibility.

### SUMMARY OF THE INVENTION

The present invention has been made to address at least the above problems, and the invention makes it possible to perform further various operating modes by differently assigning control rights of control units according to arithmetic types in a multiple-SIMD processor.

According to an aspect of the present invention, there is provided a multiple-SIMD processor for processing multimedia data, including: a host controller for assigning control right to each control unit according to an arithmetic type; first to N-th program memories each storing at least one instruction; first to N-th control units for reading instructions from the program memories according to the control right assigned by the host controller, and transferring the instructions to corresponding SIMD arithmetic units; first to N-th SIMD arithmetic units for performing arithmetic operations based on the instructions received from the control units; and a data bus for exchanging data between the SIMD arithmetic units.

According to another aspect of the present invention, there is provided an arithmetic method using a multiple-SIMD processor, including: determining, by a host controller, whether control right is required to be assigned according to an arithmetic type and assigning the control right to each control unit when the control right is required to be assigned; reading, by each control unit, at least one instruction from first to N-th program memories according to the assigned control right and transferring the instruction to a corresponding SIMD arithmetic unit among first to N-th SIMD arithmetic units; and performing, by each SIMD arithmetic unit, an arithmetic operation based on the instruction received from each control unit.

Each control unit may control the arithmetic operation to be carried out by partially or totally employing the first to N-th program memories and the first to N-th SIMD arithmetic units according to the arithmetic type.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1A is a block diagram of a processor of a conventional SIMD structure;

FIG. 1B is a block diagram of a processor of a conventional MIMD structure;

FIG. 1C is a block diagram of a processor of a conventional multiple-SIMD structure;

FIG. 1D is a block diagram of a processor of a conventional multimode structure;

FIG. 2 is a block diagram of a multiple-SIMD processor according to an exemplary embodiment of the present invention; and

FIG. 3 is a flowchart illustrating an arithmetic method using the multiple-SIMD processor according to an exemplary embodiment of the present invention.

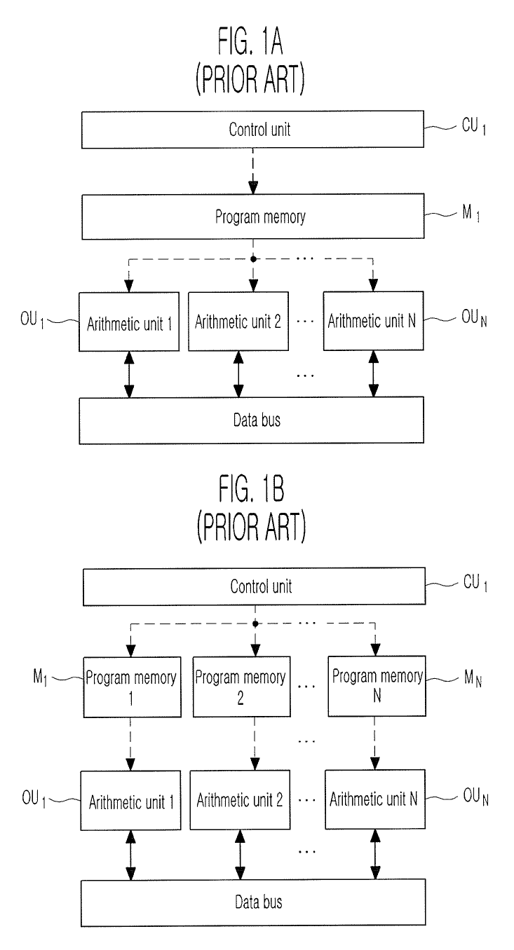

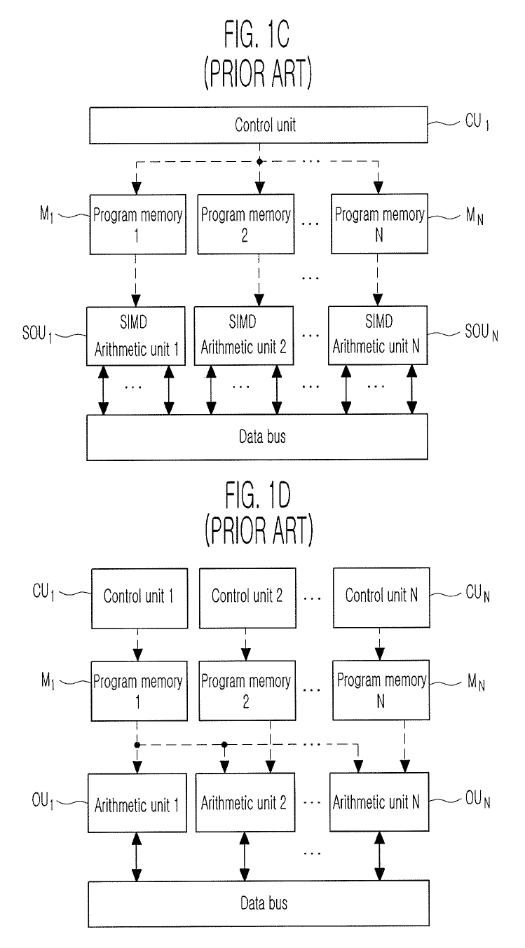

### DETAILED DESCRIPTION OF EXEMPLARY EMBODIMENTS

Hereinafter, a multiple-SIMD processor for processing multimedia data and an arithmetic method using the same according to an exemplary embodiment of the present invention will be described in detail with reference to the accompanying drawings.

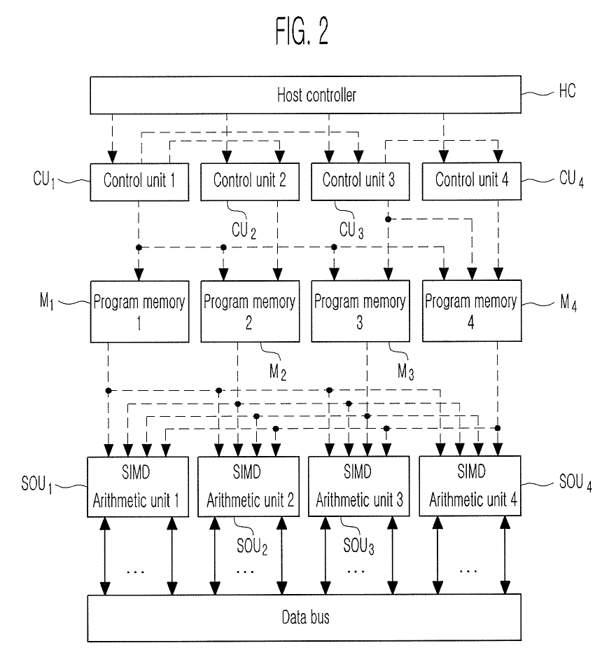

FIG. 2 is a block diagram of the multiple-SIMD processor according to an exemplary embodiment of the present invention.

Referring to FIG. 2, the multiple-SIMD processor includes a host controller HC for assigning and withdrawing control rights of control units CU₁˜CU₄ according to arithmetic types, first to fourth program memories M₁˜M₄ each storing at least one instruction, the first to fourth control units CU₁˜CU₄ for reading instructions from the program memories M₁˜M₄ according to the control rights assigned by the host controller HC and transferring the instructions to SIMD arithmetic units SOU₁˜SOU₄, the first to fourth SIMD arithmetic units SOU₁˜SOU₄ for performing arithmetic operations based on the instructions received from the control units CU₁˜CU₄, and a data bus for exchanging data between the SIMD arithmetic units SOU₁˜SOU₄.

In this exemplary embodiment, for convenience of explanation, it is assumed that the multiple-SIMD processor includes the four control units, the four program memories, and the four SIMD arithmetic units, but of course the number thereof can be changed.

First, the first control unit CU₁ has the right to control the first to fourth program memories M₁˜M₄ and the first to fourth SIMD arithmetic units SOU₁˜SOU₄. For control in an SIMD mode, the first control unit CU₁ can select one of the four program memories M₁˜M₄, read one instruction therefrom, transfer the instruction to the four SIMD arithmetic units SOU₁˜SOU₄, and control all the SIMD arithmetic units SOU₁˜SOU₄ to simultaneously perform the same arithmetic operation. Moreover, for the control in a multiple-SIMD mode, the first control unit CU₁ can read one instruction from each of the four program memories M₁˜M₄, transfer instructions to corresponding SIMD arithmetic units among the SIMD arithmetic units SOU₁˜SOU₄, and control the SIMD arithmetic units to perform different arithmetic operations.

That is, the first control unit CU₁ can use only one SIMD arithmetic unit or can selectively use two or more SIMD arithmetic units of the four SIMD arithmetic units, according to an arithmetic type.

On the other hand, the second control unit CU₂ has only the right to control the second program memory M₂ and the second SIMD arithmetic unit SOU₂. Therefore, the second control unit CU₂ reads one instruction from the second program memory M₂, transfers the instruction to the second SIMD arithmetic unit SOU₂, and controls only arithmetic units belonging to the second SIMD arithmetic unit SOU₂ to perform the same arithmetic operation.

The third control unit CU₃ has the right to control the third and fourth program memories M₃ and M₄ and the third and fourth SIMD arithmetic units SOU₃ and SOU₄. Therefore, for the control in the SIMD mode, the third control unit CU₃ can select one of the third and fourth program memories M₃ and M₄, read one instruction therefrom, transfer the instruction to the third and fourth SIMD arithmetic units SOU₃ and SOU₄, and control the third and fourth SIMD arithmetic units SOU₃ and SOU₄ to simultaneously perform the same arithmetic operation. For the control in the multiple-SIMD mode, the third control unit CU₃ can read one instruction from each of the third and fourth program memories M₃ and M₄, transfer instructions to the third and fourth SIMD arithmetic units SOU₃ and SOU₄, and control the third and fourth SIMD arithmetic units SOU₃ and SOU₄ to perform different arithmetic operations.

The fourth control unit CU₄ has only the right to control the fourth program memory M₄ and the fourth SIMD arithmetic unit SOU₄. Therefore, the fourth control unit CU₄ reads one instruction from the fourth program memory M₄, transfers the instruction to the fourth SIMD arithmetic unit SOU₄, and controls only arithmetic units belonging to the fourth SIMD arithmetic unit SOU₄ to perform the same arithmetic operation.

As described above, the multiple-SIMD processor of the present invention makes it possible to perform further various operating modes by differently assigning the control rights of the control units CU₁˜CU₄ through the host controller HC according to arithmetic types. Thus, there is an advantage in that multimedia data can be efficiently processed. The multiple-SIMD processor of the present invention can control the program memories M₁˜M₄ and the SIMD arithmetic units SOU₁˜SOU₄ to be partially used according to an arithmetic type, providing an advantage in that memory and power consumption for an arithmetic operation can be reduced.

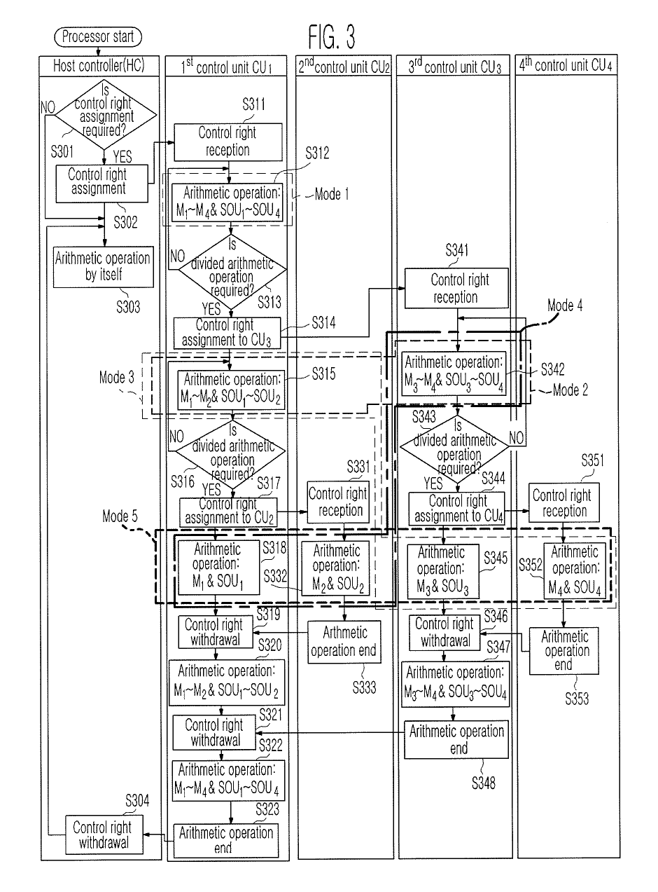

FIG. 3 is a flowchart showing an arithmetic method using the multiple-SIMD processor according to an exemplary embodiment of the present invention. For convenience of explanation, it is assumed that the first control unit CU₁ has the right to control the four program memories M₁˜M₄ and the four SIMD arithmetic units SOU₁˜SOU₄, and the first control unit CU₁ independently assigns/withdraws its own control right to control an arithmetic operation to be carried out.

First, when the multiple-SIMD processor is started, the host controller HC determines whether control right assignment is required according to an arithmetic type (S301). When the control right assignment is required, the host controller HC assigns and transfers the right to control the first to fourth program memories M₁˜M₄ and the first to fourth SIMD arithmetic units SOU₁˜SOU₄ to the first control unit CU₁ (S302). When the control right assignment is not required, the host controller HC performs processing through an arithmetic operation by itself (S303).

Then, the first control unit CU₁ controls an arithmetic operation to be carried out using the four program memories M₁˜M₄ and the four SIMD arithmetic units SOU₁˜SOU₄ according to the assigned control right (S311˜S312). At this time, the second, third, and fourth control units CU₂, CU₃, and CU₄ do not control any arithmetic operation to be carried out.

Then, the first control unit CU₁ determines whether a divided arithmetic operation is required during the arithmetic operation (S313). When the divided arithmetic operation is required, the first control unit CU₁ assigns and transfers the right to control the third and fourth program memories M₃ and M₄ and the third and fourth SIMD arithmetic units SOU₃ and SOU₄ to the third control unit CU₃ (S314) and controls the arithmetic operation to be carried out using the first and second program memories M₁ and M₂ and the first and second SIMD arithmetic units SOU₁ and SOU₂ (S315).

At this time, the third control unit CU₃ controls the arithmetic operation to be carried out using the third and fourth program memories M₃ and M₄ and the third and fourth SIMD arithmetic units SOU₃ and SOU₄ according to the control right assigned from the first control unit CU₁ (S341˜S342).

Then, the first control unit CU₁ determines whether the divided arithmetic operation is further required during the arithmetic operation (S316). When the divided arithmetic operation is further required, the first control unit CU₁ assigns and transfers the right to control the second program memory M₂ and the second SIMD arithmetic unit SOU₂ to the second control unit CU₂ (S317) and controls the arithmetic operation to be carried out using the first program memory M₁ and the first SIMD arithmetic unit SOU₁ (S318).

At this time, the second control unit CU₂ controls the arithmetic operation to be carried out using the second program memory M₂ and the second SIMD arithmetic unit SOU₂ according to the control right assigned from the first control unit CU₁ (S331˜S332).

On the other hand, the third control unit CU₃ also determines whether the divided arithmetic operation is required during the arithmetic operation (S343). When the divided arithmetic operation is required, the third control unit CU₃ assigns and transfers the right to control the fourth program memory M₄ and the fourth SIMD arithmetic unit SOU₄ to the fourth control unit CU₄ (S344) and controls the arithmetic operation to be carried out using the third program memory M₃ and the third SIMD arithmetic unit SOU₃ (S345). At this time, the fourth control unit CU₄ controls the arithmetic operation to be carried out using the fourth program memory M₄ and the fourth SIMD arithmetic unit SOU₄ according to the control right assigned from the third control unit CU₃ (S351˜S352).

That is, according to the control right assignment as described above, the multiple-SIMD processor of the present invention can perform arithmetic operations while switching the following five operating modes based on arithmetic types.

(1) First operating mode (Mode 1) is an operating mode in which the first control unit CU₁ controls an arithmetic operation to be carried out using all the program memories M₁˜M₄ and the SIMD arithmetic units SOU₁˜SOU₄.

(2) Second operating mode (Mode 2) is an operating mode in which the first control unit CU₁ controls an arithmetic operation to be carried out using the first and second program memories M₁ and M₂ and the first and second SIMD arithmetic units SOU₁ and SOU₂, and the third control unit CU₃ controls an arithmetic operation to be carried out using the third and fourth program memories M₃ and M₄ and the third and fourth SIMD arithmetic units SOU₃ and SOU₄.

(3) Third operating mode (Mode 3) is an operating mode in which the first control unit CU₁ controls an arithmetic operation to be carried out using the first and second program memories M₁ and M₂ and the first and second SIMD arithmetic units SOU₁ and SOU₂, the third control unit CU₃ controls an arithmetic operation to be carried out using the third program memory M₃ and the third SIMD arithmetic unit SOU₃, and the fourth control unit CU₄ controls an arithmetic operation to be carried out using the fourth program memory M₄ and the fourth SIMD arithmetic unit SOU₄.

(4) Fourth operating mode (Mode 4) is an operating mode in which the first control unit CU₁ controls an arithmetic operation to be carried out using the first program memory M₁ and the first SIMD arithmetic unit SOU₁, the second control unit CU₂ controls an arithmetic operation to be carried out using the second program memory M₂ and the second SIMD arithmetic unit SOU₂, and the third control unit CU₃ controls an arithmetic operation to be carried out using the third and fourth program memories M₃ and M₄ and the third and fourth SIMD arithmetic units SOU₃ and SOU₄.

(5) Fifth operating mode (Mode 5) is an operating mode in which the first to fourth control unit CU₁˜CU₄ control arithmetic operations to be carried out by respectively employing the first to fourth program memories M₁˜M₄ and the first to fourth SIMD arithmetic units SOU₁˜SOU₄.

On the other hand, when corresponding arithmetic operations are completed under controls of the first to fourth control unit CU₁˜CU₄ (S323, S333, S348, and S353), the control rights are withdrawn by assigners having assigned them (S304, S319, S321, and S346). At this time, a range of the control right of each control unit can be changed. For example, the first control unit CU₁ can further assign the right to control the second program memory M₂ and the second SIMD arithmetic unit SOU₂ to the third control unit CU₃ after withdrawing the control right of the second control unit CU₂.

In the present invention, SIMD arithmetic units configured in a parallel structure are grouped, such that one control unit can control all the SIMD arithmetic units with one instruction or each control unit can individually control the SIMD arithmetic units with different instructions, when needed.

That is, when various arithmetic operations should be individually carried out by SIMD arithmetic units in the present invention, the control right is sub-divided to perform the arithmetic operations, such that the time of the arithmetic operations can be shortened and the efficiency thereof can be raised. When sub-divided control is not required, the control right is withdrawn and the arithmetic operations are carried out using a minimum number of program memories and a minimum number of SIMD arithmetic units, such that memory and power consumption thereof can be reduced. Therefore, there is an advantage in that the arithmetic method using the multiple-SIMD processor of the present invention can raise the efficiency of arithmetic operations in various structures required to process multimedia data.

According to the present invention, one control unit can control all SIMD arithmetic units with one instruction according to an arithmetic type or each control unit can individually control the SIMD arithmetic units with different instructions, such that further various operating modes are possible and therefore the efficiency of arithmetic operations on multimedia data can be raised.

Moreover, control is possible to partially use program memories and SIMD arithmetic units according to arithmetic types, such that memory and power consumption for arithmetic operations can be reduced.

Although an exemplary embodiment of the present invention has been disclosed for illustrative purposes, those skilled in the art will appreciate that various modifications, additions, and substitutions are possible, without departing from the scope of the present invention. Therefore, the present invention is not limited to the above-described embodiment, but is defined by the following claims, along with their full scope of equivalents.

What is claimed is:

1. A multiple-single instruction multiple data (SIMD) processor for processing multimedia data, comprising:
a host controller for assigning control right to each control unit according to an arithmetic type;
first to N-th program memories each storing at least one instruction;
first to N-th control units for reading instructions from the program memories according to the control right assigned by the host controller, and transferring the instructions to corresponding SIMD arithmetic units;
first to N-th SIMD arithmetic units for performing arithmetic operations based on the instructions received from the control units; and
a data bus for exchanging data between the SIMD arithmetic units.

2. The multiple-SIMD processor of claim 1, wherein each control unit divides the assigned control right according to the arithmetic type and assigns the control right to another control unit.

3. The multiple-SIMD processor of claim 1, wherein each control unit controls an arithmetic operation to be carried out by partially or totally employing the first to N-th program memories and the first to N-th SIMD arithmetic units according to the arithmetic type.

4. The multiple-SIMD processor of claim 3, wherein each control unit reads one instruction from one of the first to N-th program memories according to the arithmetic type, transfers the instruction to a corresponding SIMD arithmetic unit, and controls only arithmetic units belonging to the corresponding SIMD arithmetic unit to perform the same arithmetic operation.

5. The multiple-SIMD processor of claim 3, wherein each control unit reads N instructions from the first to N-th program memories according to the arithmetic type, transfers the instructions to the first to N-th SIMD arithmetic units, and controls the SIMD arithmetic units to simultaneously perform different arithmetic operations.

6. An arithmetic method using a multiple-single instruction multiple data (SIMD) processor, comprising:
determining, by a host controller, whether control right is required to be assigned according to an arithmetic type and assigning the control right to each control unit when the control right is required to be assigned;
reading, by each control unit, at least one instruction from first to N-th program memories according to the assigned control right and transferring the instruction to a corresponding SIMD arithmetic unit among first to N-th SIMD arithmetic units; and
performing, by each SIMD arithmetic unit, an arithmetic operation based on the instruction received from each control unit.

7. The arithmetic method of claim 6, wherein the reading, by each control unit, at least one instruction from first to N-th program memories includes: determining, by each control unit, whether a divided arithmetic operation is required during the arithmetic operation and dividing its own control right to assign the control right to another control unit when the divided arithmetic operation is required.

8. The arithmetic method of claim 6, wherein the reading, by each control unit, at least one instruction from first to N-th program memories includes: controlling, by each control unit, the arithmetic operation to be carried out by partially or totally employing the first to N-th program memories and the first to N-th SIMD arithmetic units according to the arithmetic type.

9. The arithmetic method of claim 8, wherein the reading, by each control unit, at least one instruction from first to N-th program memories further includes: reading, by each control unit, one instruction from one of the first to N-th program memories according to the arithmetic type, transferring the instruction to a corresponding SIMD arithmetic unit, and controlling only arithmetic units belonging to the corresponding SIMD arithmetic unit to perform the same arithmetic operation.

10. The arithmetic method of claim 8, wherein the reading, by each control unit, at least one instruction from first to N-th program memories further includes: reading, by each control unit, N instructions from the first to N-th program memories according to the arithmetic type, transferring the instructions to the first to N-th SIMD arithmetic units, and controlling the SIMD arithmetic units to simultaneously perform different arithmetic operations.
